(19) United States
(12) Patent Application Publication
(10) Pub. No.: US 2008/0042471 A1
(43) Pub. Date: Feb. 21, 2008

(54) HEAD IMPACT COUNTERMEASURE SYSTEM FOR AUTOMOTIVE VEHICLE

(75) Inventors: Richard Kirn, Ann Arbor, MI (US); Robert R. Armitage, Howell, MI (US); Robert W. Bartus, Allen Park, MI (US); Kenneth S. Laird, Canton, MI (US)

Correspondence Address: Dickinson Wright PLLC, 38525 Woodward Avenue, Suite 2000, Bloomfield Hills, MI, 48304, US

(73) Assignee: FORD GLOBAL TECHNOLOGIES, LLC, Dearborn, MI (US)

(21) Appl. No.: 11/465,486

(22) Filed: Aug. 18, 2006

(51) Int. Cl. B60R 13/02

(52) U.S. Cl. 296/214

(57) ABSTRACT

A head impact countermeasure system for an automotive vehicle includes a headliner fastened to the vehicle's roof and extending over a passenger compartment of the vehicle. At least one buffer extends rearwardly from the headliner into a cargo compartment of the vehicle along a roof siderail. The buffer is preferably formed from plastic foam and has an inner surface contoured to the siderail and an outer surface contoured to match the contour, grain, and color pattern of the headliner.

### BACKGROUND OF THE INVENTION

1. Field of the Invention

The present invention relates to a system for providing a countermeasure in the event that a vehicle's occupant impacts a roof siderail during a crash.

2. Disclosure Information

FMVSS 201 requires that manufacturers of certain passenger cars, trucks, buses, and multi-purpose vehicles provide head impact protection, including protection in the event of collision-related contact between an occupant's head and the roof siderail of a vehicle. Van-type vehicles present a particular challenge to manufacturers, because although certain vans are outfitted with seating which fills almost the entire interior space of the van, other vans have but a single row of seats at the front of the van for accommodating only the driver and a single passenger. In the latter type of configuration, which is shown as prior art in FIG. 4, headliner 60 is installed at the front part of the vehicle over the passenger compartment. The headliner is followed by a headliner extension, 64, which continues back a distance along the central axis of the vehicle to lateral roof rib 63. The purpose of headliner extension 64 is to reduce the likelihood of head injury upon contact with siderail 68 of roof 58. Unfortunately, the configuration shown in FIG. 4 is needlessly costly for the vehicle manufacturer and, therefore, the customer, because the headliner extension is generally used in an area rearward of the seats, where it is not needed as an impact countermeasure other than in the portion of the roof area occupied by siderail 68. Although it would be possible to merely apply crudely fitted blocks of plastic foam to roof siderail 68 to conform with Federal Motor Vehicle Safety Standards, such an installation would be neither be aesthetically acceptable, nor functionally equivalent to the present inventive solution.

A head impact countermeasure system according to the present invention provides a robust, cost-effective head impact countermeasure system, without the necessity of extending a headliner over portions of the interior of a vehicle which are devoted to carrying cargo.

### SUMMARY OF THE INVENTION

A head impact countermeasure system for an automotive vehicle having a fixed roof includes a headliner fastened to the roof and extending over a passenger compartment of the vehicle, and at least one buffer extending rearwardly from the headliner and into a cargo compartment of the vehicle along a siderail of the roof. The buffer may be formed as a plastic foam block having an inner surface molded to conform with the siderail, and an outer surface molded to conform with at least part of the headliner. The buffer preferably has a surface finish with an appearance matched to the appearance of the headliner, as well as to other trim components.

According to another aspect of the present invention, the buffer may be formed from expanded polypropylene foam.

According to another aspect of the present invention, a headliner may include a trim panel having a number of plastic foam blocks mounted to a rear face of the trim panel, with each of the molded plastic foam blocks having a leading end underlying a portion of the headliner. The headliner and the plastic foam buffers or blocks preferably interleave in the location of a B-pillar.

It is an advantage of a head impact countermeasure system according to the present invention that protection may be provided to vehicle occupants without the necessity of mounting a complete headliner rearwardly of the passenger compartment in a combination passenger/cargo vehicle lacking seats behind the row containing the driver's seat.

It is another advantage of the present invention that the elimination of a headliner advantageously reduces the cost of vehicle maintenance of a cargo van by avoiding damage caused by the incidental impact of cargo against a headliner.

It is yet another advantage of a head impact countermeasure system according to the present invention that both cost and weight are reduced by implementation of the present system, as opposed to a complete headliner system.

Other advantages, as well as features and objects of the present invention, will become apparent to the reader of this specification.

### BRIEF DESCRIPTION OF THE DRAWINGS

FIG. 1 is a perspective view of the interior of a van-type vehicle having the present inventive head impact countermeasure system.

FIG. 2 is a perspective view of a plastic foam buffer according to one aspect of the present invention. FIG. 2 illustrates the outer portion of the plastic foam bumper.

FIG. 3 illustrates the inner surface of the plastic foam bumper of FIG. 2.

FIG. 4 illustrates a prior art van having an extended headliner.

### DETAILED DESCRIPTION OF THE PREFERRED EMBODIMENTS

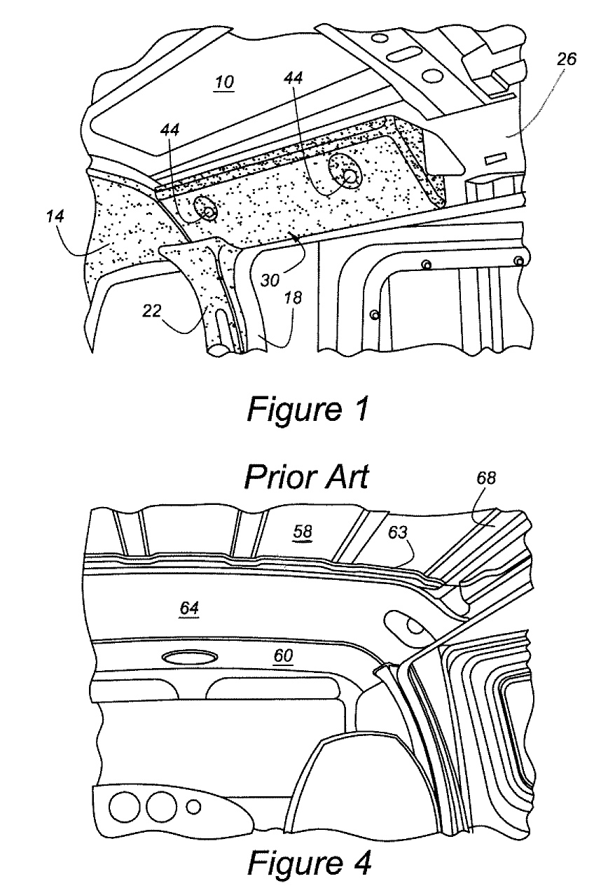

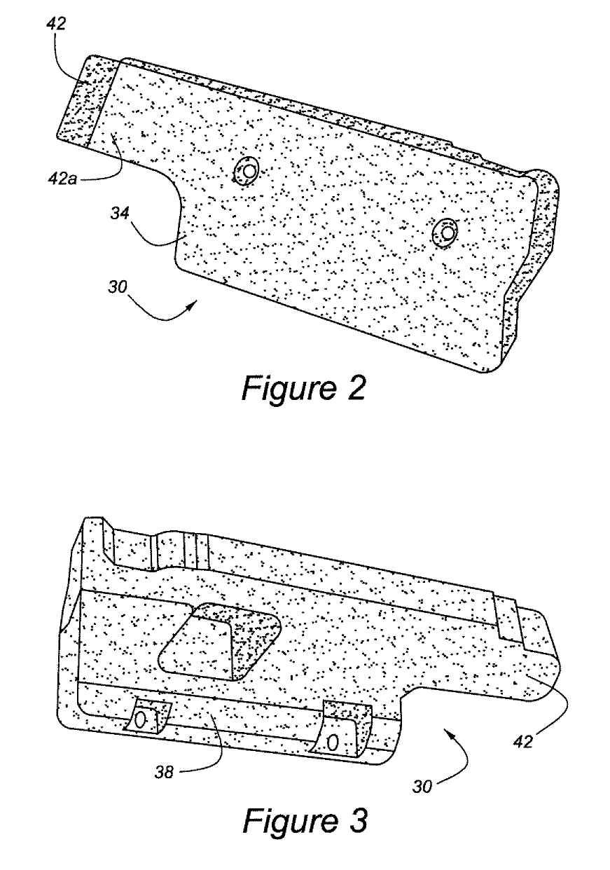

As shown in FIG. 1, a vehicle has a roof, 10, to which headliner 14 is affixed. Headliner 14 extends over only the passenger compartment of the vehicle. Buffer 30, which is molded from plastic foam, such as expanded polypropylene foam, is attached to roof siderail 26 by means of axially engageable pushpins 44. Note that the leading end of buffer 30, which is shown at 42 in FIG. 2, is interleaved under the trailing edge of headliner 14. Also it should be noted from FIG. 2 that buffer 30 has a leading end 42a, which is molded to conform with the contour of headliner 14 in the region conjoined by buffer 30. The inner surface of buffer 30, which is shown in FIG. 3, is molded to conform with the configuration of roof siderail 26. Although passenger side componentry is shown in FIGS. 1-3, those skilled in the art will appreciate in view of this disclosure that the driver's side componentry may conveniently be constructed as a mirror image of the illustrated parts.

Headliner 14 and buffer 30 are abutted at the location of B-pillar 18. B-pillar molding 22 and headliner 14 and buffer 30 are colored and grained identically so that their surface appearance is identical. In this manner, it is not necessary to apply a separate vinyl covering to buffer 30, and yet buffer 30 may be rendered aesthetically compatible with headliner 14 and B-pillar molding 22.

The material of buffer 30, as noted above, is preferably molded from plastic foam, such as expanded polypropylene foam. The present inventors have determined that although expanded polypropylene foam exhibits the performance requirements desired for use in the present automotive application, blocks formed from yet other types of plastic foam, such as polyurethane foam, may be employed according to the present invention to mitigate the potential for head injury.

While particular embodiments of the invention have been shown and described, numerous variations and alternate embodiments will occur to those skilled in the art. Accordingly, it is intended that the invention be limited only in terms of the appended claims.

What is claimed is:

1. A head impact countermeasure system for an automotive vehicle having a fixed roof, with said impact countermeasure system comprising:
a headliner fastened to said roof and extending over a passenger compartment of said vehicle; and
at least one buffer extending rearwardly from said headliner and into a cargo compartment of said vehicle along a side rail of said roof.

2. A head impact countermeasure system according to claim 1, wherein said buffer comprises a plastic foam block having an inner surface molded to conform with said side rail.

3. A head impact countermeasure system according to claim 2, wherein an outer surface of said plastic foam block and said headliner are finished in a common grain pattern.

4. A head impact countermeasure system according to claim 2, wherein said plastic foam block has an outer surface molded to conform with at least one contour of said headliner.

5. A head impact countermeasure system according to claim 1, wherein said plastic foam block comprises expanded polypropylene foam.

6. A head impact countermeasure system according to claim 1, wherein said plastic foam block comprises polyurethane foam.

7. A head impact countermeasure system according to claim 2, wherein said headliner comprises at least one plastic foam block adhered to a back side of the headliner.

8. A head impact countermeasure system according to claim 1, wherein said buffer comprises a plastic foam block having an inner surface molded to conform with said side rail, an outer surface molded to conform with at least part of said headliner, and a surface finish having an appearance matched to the appearance of said headliner.

9. A head impact countermeasure system for an automotive vehicle having a single fixed roof covering both a front passenger compartment and an adjoining cargo compartment, with said roof having left and right side rails, and with said impact countermeasure system comprising:
a headliner comprising a trim panel having a plurality of plastic foam blocks mounted to a rear face of the trim panel, with said trim panel extending over said front passenger compartment; and
a plurality of molded plastic foam buffers, with said buffers extending rearwardly into said cargo compartment along, and enclosing, a portion of each of said left and right side rails from a location adjoining a rearward part of said headliner.

10. A head impact countermeasure system according to claim 9, wherein said headliner and said molded plastic foam buffers are finished with a common grain pattern.

11. A head impact countermeasure system according to claim 9, wherein said headliner and said molded plastic foam buffers are finished with a common grain pattern.

12. A head impact countermeasure system according to claim 9, wherein each of said molded plastic foam buffers extends rearwardly from the location of a B-pillar.

13. A head impact countermeasure system according to claim 9, wherein each of said molded plastic foam buffers has a leading end underlying a portion of said headliner.

14. A head impact countermeasure system according to claim 9, wherein each of said molded plastic foam buffers is retained to one of said roof side rails by an axially engageable fastener.
